(19) United States
(12) Patent Application Publication
(10) Pub. No.: US 2012/0124628 A1
(43) Pub. Date: May 17, 2012

(54) METHOD FOR REQUESTING TRANSMISSION OF BROADCAST PROGRAM AND METHOD FOR TRANSMITTING BROADCAST PROGRAM

(75) Inventors: Soon Choul KIM, Daejeon-si (KR); Dong Joon CHOI, Daejeon-si (KR); Ho Sook LEE, Daejeon-si (KR); Soo In LEE, Daejeon-si (KR)

(73) Assignee: Electronics and Telecommunications Research Institute, Daejeon-si (KR)

(21) Appl. No.: 13/293,645

(22) Filed: Nov. 10, 2011

(30) Foreign Application Priority Data
Nov. 12, 2010 (KR) 10-2010-0112910

(51) Int. Cl. H04N 7/173

(52) U.S. Cl. 725/87

(57) ABSTRACT

A mobile terminal constituting a multi-screen service environment in a switched digital video (SDV)-based video transmission system structure serves like a remote controller of a reception terminal having a large screen such as a TV. A broadcast channel viewed in the mobile terminal can be shared with the large screen of the TV or the like, and a program can be directly viewed in the large screen of the TV or the like based on program guide information received by the mobile terminal.

### CROSS-REFERENCE TO RELATED APPLICATIONS

This application claims the benefit of priority of Korean Patent application No. 10-2010-0112910 filed on Nov. 12, 2010, which is incorporated by reference in their entirety herein.

### BACKGROUND OF THE INVENTION

1. Field of the Invention

The present invention relates to a video transmission system and, more particularly, to a video transmission system based on a switched digital video in a multi-screen service environment.

2. Description of the Related Art

Recently, users of an Internet protocol television (referred to as ‘IPTV’, hereinafter), along with a cable television, is greatly increasing.

IPTV refers to services such as information services, video contents, broadcasts, or the like, delivered to a receiver terminal including a television receiver, or the like, by using high-speed Internet. IPTV can be configured to be a type of digital convergence in the aspect that the Internet and television are converged.

The use of IPTV requires a television receiver, a set-top box (STB), an Internet line, or the like. A user, although he is not familiar with computers, can be provided with various contents and supplementary services provided by service providers through the Internet, so the user can perform Internet search (or surfing), enjoy movies, do the home shopping, do the home banking, play online games or MP3, or the like, by using a controller such as a remote controller.

IPTV is not much different from the general cable broadcasts or satellite broadcast in that it provides broadcast contents including video, but is distinguishable in that it has bi-directionality. Unlike the general air interface broadcasts, cable broadcasts, or satellite broadcasts, viewers can view their desired program at a desired time. Thus, the viewers can have the upper hand of TV broadcasts.

Meanwhile, viewers view or use broadcast programs and/or contents through terminals of various specifications, e.g., various sizes and performances. In this with this, cable TV broadcast providers or IPTV broadcast providers constitute different channels according to encoding schemes, resolution, and the like, suitable for the terminals having the various sizes and performances. Broadcast programs and contents are transmitted via differently configured channels.

Users can select a channel suitable for viewing broadcasts and/or contents according to the performance of a terminal he uses to receive a broadcast program and/or contents.

### SUMMARY OF THE INVENTION

Therefore, an object of the present invention is to provide a method for allowing a plurality of terminals to share the same broadcast contents in a multi-screen environment.

Another object of the present invention is to provide a method for allowing one terminal to regulate an output channel of another terminal in a multi-screen environment.

Still another object of the present invention is to provide a method for supporting mobility of a broadcast service user in a multi-screen environment.

Yet another object of the present invention is to provide a method for effectively utilizing broadcast resources in a multi-screen environment.

To achieve the above objects, there is provided a method for requesting a transmission of a program by a terminal in a switched digital video (SDV)-based multi-screen system, including: requesting, by a first terminal, a transmission of a selected program from a server; receiving, by the first terminal, the program through first data streaming from the server; outputting, by the first terminal, the program; and when the program is selected to be output to a second terminal, transmitting, by the first terminal, a program transmission request for requesting a transmission of the program to the second terminal, to the server.

The program transmission request may include information for designating the speed of second data streaming for transmitting the program from the server to the second terminal.

The speed of the second data streaming may be faster than that of the first data streaming, and the second terminal may be a mobile terminal.

The program transmission request may include information regarding an IP address of the second terminal.

The second data streaming may be transmitted via a multicast channel.

To achieve the above objects, there is also provided a method for requesting a transmission of a program in a switched digital video (SDV)-based multi-screen system, including: selecting, by a first terminal, a program to be output to a second terminal; and transmitting, by the first terminal, a program transmission request for requesting a transmission of the program to the second terminal, to a server.

The method may further include: selecting, by the first terminal, the speed of data streaming of the program transmitted to the second terminal, wherein the program transmission request may include information regarding the selected speed of data streaming.

The selected speed of data streaming may be faster than the speed of data streaming transmitted to the first terminal.

The program transmission request may be a request for transmitting the program from the second terminal through data streaming faster than the data streaming transmitted to the first terminal.

The program transmission request may include information regarding an IP address of the second terminal.

The second terminal may be a mobile terminal.

The program transmission request may be a request for transmitting the program to the second terminal via a multi-cast channel.

To achieve the above objects, there is also provided a method for transmitting a program by a server in a switched digital video (SDV)-based multi-screen system, including: receiving a first transmission request for requesting a transmission of a program from a first terminal; transmitting the program through first data streaming to the first terminal; receiving a second transmission request for requesting a transmission of the program to a second terminal, from the first terminal; checking information regarding the domain of the second terminal; and transmitting the program to the second terminal through second data streamlining.

The speed of the second data streaming may be faster than that of the first data streaming.

The checking of the information regarding the domain of the second terminal may include: checking whether or not the second terminal has joined a multi-cast group, wherein when the second terminal has joined a multi-cast group, the program is multicast through the second data streaming, and when the second terminal has not joined a multi-cast group, the second terminal joins a multi-cast group and the program is multicast through the second data streaming.

Whether or not the second terminal has joined a multi-cast group may be checked by checking whether or not an IP address of the second terminal has joined the multi-cast group.

The method may further include: checking a channel transmission state with respect to the domain of the second terminal, wherein the transmission speed of the second data streaming is regulated according to the channel transmission state.

The method may further include: checking a channel transmission state with respect to the domain of the second terminal, wherein a transmission scheme with respect to the second terminal is determined according to the channel transmission state.

According to an exemplary embodiment of the present invention, a plurality of terminals can share the same broadcast contents in a multi-screen environment.

According to an exemplary embodiment of the present invention, one terminal can regulate an output channel of another terminal in a multi-screen environment.

Mobility of a broadcast service user can be supported in a multi-screen environment,

Broadcast resources can be effectively utilized in a multi-screen environment.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram of a general switched digital video (SDV) system.

FIG. 2 is a schematic block diagram of a broadcast/video service system according to an exemplary embodiment of the present invention.

FIG. 3 is a flow chart illustrating the process of shifting broadcast/video program contents from a preview terminal 230 to a main view terminal 240.

FIG. 4 is a view illustrating an example of the configuration of a screen of the preview terminal.

FIG. 5 is a flow chart illustrating the process of requesting a transmission of a broadcast/video program by the preview terminal according to an exemplary embodiment of the present invention.

### DETAILED DESCRIPTION OF THE INVENTION

Users increasingly use services with a smart TV or services in a multi-screen environment. In line with this, a technique for allowing users of several terminals to view the same broadcast of a TV or video or allowing several terminals to share the same program of a TV or video is considered. In particular, a method for controlling of sharing contents or shifting contents is required in a multi-screen environment.

As described above, a cable broadcast and/or IPTV broadcast provider constitutes different channels according to encoding schemes, resolution, and the like, appropriate to terminals having various sizes and performances in the multi-screen environment. Broadcast programs and contents are transmitted via separately configured channels.

In this case, a method for allowing a plurality of terminals of a user, who uses the cable broadcast or IPTV broadcast service, to share or shift contents therebetween is required. In an exemplary embodiment of the present invention, the user may select a channel of a different terminal by using a particular terminal. Also, in an exemplary embodiment of the present invention, the particular terminals, e.g., a mobile terminal and a large-screen TV receiver, of the user can share the channel currently viewed by the user.

Meanwhile, in line with an activation of smart TVs, an increase in IPTV users, an increase in various broadcast contents, and the like, broadcast resources required by broadcast providers transmitting programs are increasing, and accordingly, a method for effectively using broadcast resources is sought. According to an exemplary embodiment of the present invention, limited broadcast resources can be effectively utilized.

An IP-based switched digital video (SDV) is a selection type (video) program transmission technique, which is also called a switched digital broadcasting (SDB).

When a broadest service subscriber selects a channel, the SDV actually transmits a broadcast program corresponding to the channel. In general, the SDV statistically analyzes broadcast channels viewed by the data broadcast service subscriber and transmits channels having high frequency in a general broadcast. As for channels having low frequency statistically, the SDV transmits them upon receiving the service subscriber's selection or request.

Thus, the limited broadcast resources, e.g., broadcast frequencies, or the like, can be effectively used. A broadcast service provider can provide a supplementary service such as a high picture quality video on demand (VOD), or the like, or transmit commercials (or advertisements) by using a broadcast frequency remaining after transmitting broadcast programs.

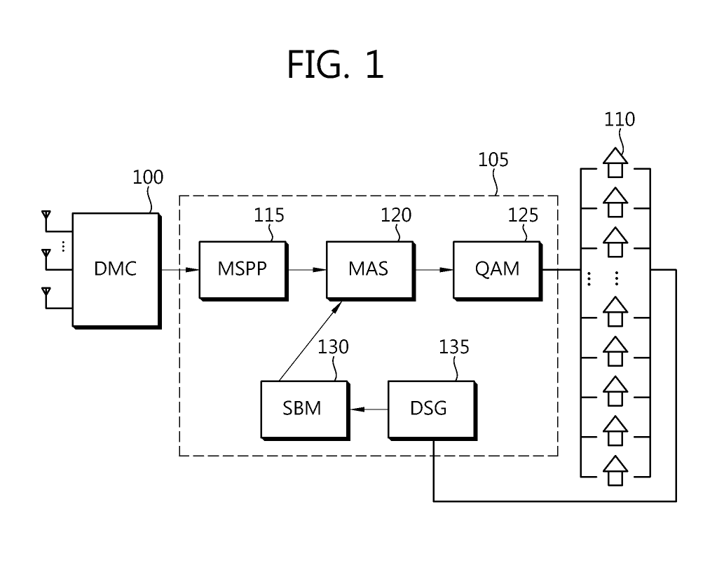

FIG. 1 is a schematic block diagram of a general switched digital video (SDV) system.

The overall configuration of the SDV system includes a digital media center (DMC) 100, a system operator (SO) 105, and a user 110 who uses a broadcast service, and so on.

The DMC 100, configured by converging digital broadcast-related facilities and systems, provides a digital service to individual SOs.

The SO 105 is a broadcast provider, namely, a provider of a cable TV, a local area broadcast station, an IPTV, or the like. In FIG. 1, it is illustrated that the DMC 100 provides a digital service to the SO 105, but the present invention is not limited thereto and the SO 105 may include a digital service providing system and use the same, rather than using the DMC commonly providing a digital service.

General function units constituting the SO 105 include a multi-service provisional platform (MSPP) 115, an MPEG-aware switch (MAS) 120, a queued access method (QAM) 125, a switched broadcast manager (SBM) 130, a DSG 135, and the like.

The MSPP 115 can provide a high quality, reliable Ethernet service at various rates as desired by users by using the existing SDH technique and new techniques such as virtual concatenation, LCAS, GFP, MPLS, and the like. An exchange function of an IP switch, a DWDM, an OXC, and the like, can be integrated by using the MSPP 115. Also, various services such as a voice service, a wavelength service, a gigabit service, and the like, can be provided to users by using the MSPP 115.

The MAS 120 receives real-time broadcast data, e.g., an MPEG stream, and delivers only broadcast data desired to be viewed by a viewer according to an instruction of the SEM 130. The QAM 125 resolves a time delay problem when inputting and outputting is performed, by automatically synchronizing a data transmission between a program and an input/output device.

The SBM 130 determines which channels the viewers of a particular area or a particular domain are currently viewing upon receiving a channel request from the users. The SBM 130 delivers which channel is to be transmitted to which area or which domain, to the MAS 120 based on the determination.

The user 110, specifically, a switched broadcast client (SBC) installed in a set-top box (SBC), or the like, used by the user, transmits information regarding a channel as selected by the user to the SBM 130 through a set-top gateway (SG) 135.

Here, the data streaming has been described by using compressed data such as MPEG, or the like, but it could be understood that it is to easily explain the present invention and the present invention is not meant to be limited thereto, and the broadcast/video providing service according to an exemplary embodiment of the present invention can utilize diverse data compression techniques.

Also, as for the respective function elements of the SDV described herein, the applied techniques are limitedly described to easily explain the schematic content of the SDV, but the present invention is not meant to be limited thereto, and the user may use various techniques within the scope of the technical concept of the present invention in order to selectively transmit a desired broadcast/video program. In addition, some of the elements of the SDV as mentioned above may be replaced or excluded for the original selective broadcast/video program transmission service of the SDV.

Exemplary embodiments of the present invention will now be described in detail with reference to the accompanying drawings. In applying reference numerals to elements of each drawing, the same reference numerals are used for the same elements although they are shown on different drawings. In describing the present invention, if a detailed explanation for a related known function or construction is considered to unnecessarily divert the gist of the present invention, such explanation has been omitted but would be understood by those skilled in the art.

It will be understood that, although the terms first, second, A, B, (a), or (b) may be used herein to describe various elements, these elements should not be limited by these terms. These terms are only used to distinguish one element from another, without limiting the essence, order, or sequence of corresponding elements. It will also be understood that when an element is referred to as being “connected with” or “coupled to” another element, it can be directly connected with the other element or intervening elements may also be present. In contrast, when an element is referred to as being “directly connected with” or “directly coupled to” another element, there are no intervening elements present.

Also, in the description of the present disclosure, an operation performed in a communication network may be performed in the process of controlling a network and transmitting data by a system (e.g., a server or a media center) administering the corresponding communication network, or may be performed by a terminal coupled to the corresponding network.

Throughout the specification and claims, unless explicitly described to the contrary, the word “comprise” and variations such as “comprises” or “comprising”, will be understood to imply the inclusion of stated elements but not the exclusion of any other elements.

In an exemplary embodiment of the present invention, a mobile terminal constituting a multi-screen service environment in a switched digital video (SDV)-based video transmission system structure serves like a remote controller of a reception terminal, such as a TV, having a large screen. According to the present exemplary embodiment, a broadcast channel viewed on the mobile terminal can be shared by the TV having a large screen. Also, a program can be viewed on a large screen of the TV, or the like, from program guide information received by the mobile terminal.

Recently, technologies such as smart TVs, multi-screens, or the like, have emerged and a broadcast network and a communication network are rapidly made to include IPs. Broadcast/video providers need to consider an effective transmission of contents, which are desired to be provided, on IP and sharing and controlling of broadcast contents between terminals. The present invention effectively provides services with respect to a multi-screen in an IP-based SDV transmission system.

In a multi-screen service environment, broadcast providers configure separate channels according to the characteristics and types of respective terminals to provide services. Accordingly, the number of times of signaling between the systems of the broadcast providers and the respective terminals increases to increase the load of a network, the systems and the terminals. In an exemplary embodiment of the present invention, a mobile terminal, e.g., a preview terminal (to be described), is able to effectively control viewing with respect to other reception terminals in the IP-based SDV environment. Thus, complex signaling in the communication network can be minimized according to an exemplary embodiment of the present invention.

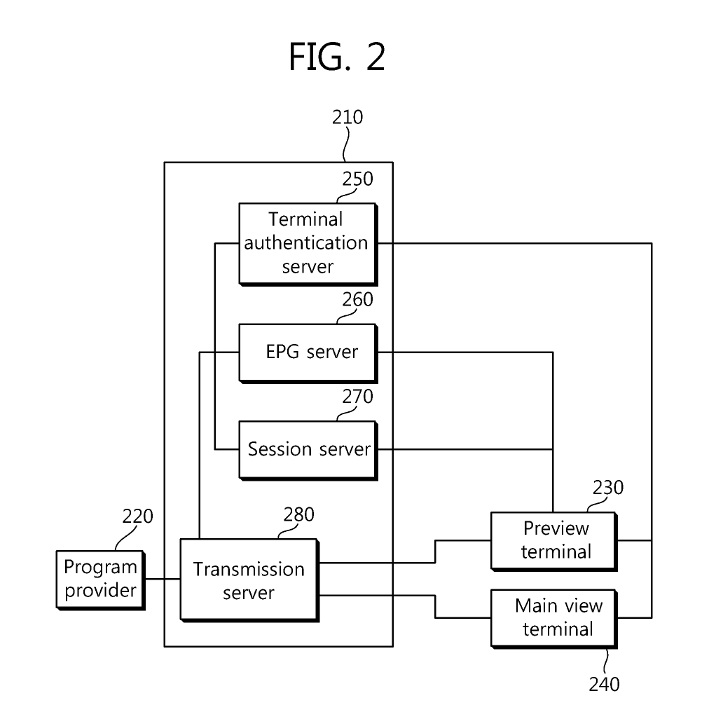

FIG. 2 is a schematic block diagram of a broadcast/video service system according to an exemplary embodiment of the present invention.

An SDV system 210 is provided with a broadcast/video program from a program provider 220. Some of the program providers 220 may provide real-time broadcast streaming and the other of the program providers 220 may provide video contents, and a single program provider may provide both real-time broadcast streaming and video contents. Also, the SDV system 210 may receive only the real-time broadcast streaming from the program provider 220 and an operator of the SDV system 210 may have video contents of its own required for a broadcast/video program service.

In the multi-screen environment, reception terminals having various formats and performances are used. The program provider 220 or the operator of the SDV system 210 may configure broadcast streaming which is coded according to and has various resolutions to provide programs.

When there is a particular program transmission request from one or more terminals, namely, from the user, the SDV system 210 may transmit the corresponding program. Also, in case of a program which is statistically in great demand, the SDV system 210 may transmit the program in a broadcast manner and may transmit other programs only when there is a transmission request from the user.

A preview terminal 230 is a terminal for outputting the broadcast/video programs transmitted from the SDV system 210. The preview terminal 230 may be a portable mobile terminal such as a smartphone, a tablet PC, or the like.

A main view terminal 240 is a terminal for outputting the broadcast/video programs transmitted from the SDV system 210. The main view terminal 240 is a large screen terminal having a generally excellent performance compared with the mobile terminal.

A terminal authentication server 250 of the SDV system 210 performs a procedure regarding a registration and/or authentication of the terminal which wants to use an SDV-based broadcast/video service. The user, who wants to use the service, registers his terminal to be used to the terminal authentication server 250. For example, when the user wants to use the preview terminal 230 and the main view terminal 240, the user registers the two terminals to the terminal authentication server 250. When the registered user wants to use the service, the terminal authentication server 250 performs a user authentication procedure.

An electronic program guide (EPG) server 260 of the SDV system 210 performs a procedure of configuring a broadcast/video program information called an EPG or an interactive program guide (IPG) and transmitting the same to the terminals. The preview terminal 250 may periodically receive program guide information from the EPG server 260. Also, the preview terminal 230 may receive channel information broadcast from the EPG server 260. The received program guide information and/or channel information is output to the screen of the preview terminal 230.

Also, when required, the user may receive the program guide information and/or the channel information by the main view terminal 240. The main view terminal 240 may receive the program guide information and/or the channel information from the EPG server 260 or may receive required information from the preview terminal 230 which has received the program guide information and/or the channel information from the EP server 260.

The user may select a desired broadcast/video program from the program guide information and/or the channel information output to the terminals 230 and 240.

A session server 270 of the SDV system 210 performs a procedure regarding a channel operation/management of a broadcast/video program when the user selects or releases a program channel. When the user selects a desired broadcast/video program from the preview terminal 230, the preview terminal 230 transmits a request for a transmission of the corresponding broadcast/video program to the session server 270.

The user may select a desired broadcast/video program from the main view terminal 240. In this case, the main view terminal 240 may transmit a request for a transmission of the corresponding broadcast/video program to the session server 270. Also, the main view terminal 240 may transmit information regarding the selected broadcast/video program to the preview terminal 230. In this case, the preview terminal 230 transmits a request for a transmission of the corresponding broadcast/video program to the session server 270, in the place of the main view terminal 240.

A transmission server 280 of the SDV system 210 performs a procedure regarding the broadcast/video program. When there is a particular program transmission request from the user, the transmission server 280 may transmit the corresponding program. Also, in case of a program which is statistically in great demand or a broadcast, e.g., a terrestrial/radiowave broadcast, streamed in real time from a program provider, the transmission server 280 may transmit the program in a broadcast manner and may transmit other programs only when there is a transmission request from the user.

When there is a request for a transmission of a broadcast/video program from the user, the session server 270 requests the transmission server 280 to transmit the corresponding broadcast/video program to a terminal connected by the user or a terminal designated by the user.

Information regarding the terminal to which the broadcast/video program is to be transmitted may be checked by the terminal authentication server 250, may be checked by the session server 270 along with a user's transmission request, or may be checked by the transmission server 280 in order to transmit the corresponding broadcast/video program.

In this case, the user may include IP information of the terminal to which the broadcast/video program is to be transmitted in the request for a transmission of the broadcast/video program and transmit the same. Also, the terminal to which the broadcast/video program is to be transmitted may be specified by an IP address of the terminal which has been used for terminal authentication in the SDV system 210. Also, the SDV system 210 may obtain information regarding the IP address to which the request for a transmission of the broadcast/video program has been transmitted, and specify a terminal to which the broadcast/video program is to be transmitted.

When there is a request for a transmission of the broadcast/video program from the preview terminal 230, the SDV server 280 transmits the corresponding broadcast/video program to the preview terminal 230 via a channel for the preview terminal. Also, when there is a request for a transmission of the broadcast/video program from the main view terminal 240, the SDV server 280 transmits the corresponding broadcast/video program to the main terminal 240 via a channel for the main view terminal. Also, when there is a request for a transmission of the broadcast/video program to the main view terminal 240, from the preview terminal 230, the SDV server 280 transmits the corresponding broadcast/video program to the main view terminal via the channel for the main view terminal. Thus, in this case, the broadcast/video program contents in use are moved from the preview terminal 230 to the main view terminal 240.

Here, the channel for the main view terminal and the channel for the preview terminal are described as a channel dedicated for the main view terminal and a channel dedicated for the preview terminal, but the present invention is not meant to be limited thereto. The SDV server 280 may transmit the broadcast/video program by using both channels to the respective terminals according to the performance of the preview terminal 230 and the main view terminal.

A case in which the user wants to view a broadcast/video program, currently viewed by the preview terminal 230, by the main view terminal 240 will now be described.

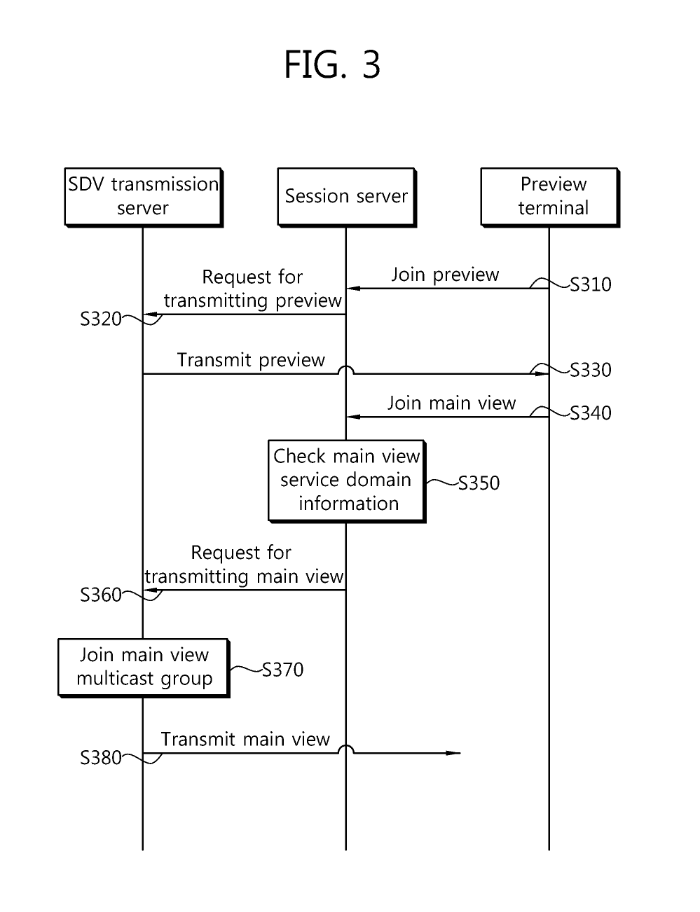

FIG. 3 is a flow chart illustrating the process of shifting broadcast/video program contents from the preview terminal to the main view terminal.

With reference to FIG. 3, the preview terminal is authenticated by the terminal authentication server and then selects a broadcast/video program selected from a program guide screen in order to view it by the preview terminal. The preview terminal transmits a request for a transmission of the selected broadcast/video program, namely, a preview join message, to the session server (S310). The preview join message may include information regarding the selected broadcast/video program and information regarding the preview terminal.

Upon receiving the broadcast/video program, the session server requests a transmission of the corresponding broadcast/video program from the SDV server (S320).

The information regarding the preview terminal to which the broadcast/video program is to be transmitted may be included in the request for a transmission of the broadcast/video program. Also, the preview terminal may be specified by an IP address of the terminal obtained in authenticating a terminal in the SDV system. Also, the preview terminal may be specified by an IP address to which the request for a transmission of the broadcast/video program has been transmitted.

In response to the request from the session server, the SDV server transmits a broadcast/video program which can be viewed by the preview terminal, namely, a preview, to the preview terminal (S330). The user of the preview terminal may determine that he will view the corresponding broadcast/video program by the main view terminal, while viewing the received preview.

When the user of the preview terminal determines to view the corresponding broadcast/video program by the main view terminal, the user transmits a main view join message requesting a transmission of the corresponding broadcast/video program to the main view terminal from the preview terminal to the session server (S340). Besides the method of transmitting the main view join message to the session server by the user while viewing the preview on the preview terminal, the user may request a transmission of the corresponding broadcast/video program directly from the main view terminal, rather than viewing the preview on the preview terminal.

The main view join message may include the broadcast/video program information currently viewed on the preview terminal and information regarding the main view terminal. In this case, the information regarding the main view may include information regarding an IP address of the main view terminal.

Meanwhile, the user may transmit the broadcast/video program information from the preview terminal to the main view terminal. Upon receiving the broadcast/video program information from the preview terminal, the main view terminal may perform a procedure required for receiving the broadcast/video program in advance.

The session server receives the main view join message and checks information regarding a service domain to which the user's main view terminal belongs (S350). The session server checks a channel state of the service domain to which the user's main view terminal belongs to and requests the SDV transmission server to transmit the user selected broadcast/video program to the user's main view terminal (S360). In this case, the session server may update the information regarding the user's main view terminal, the information regarding the service domain to which the user's main view terminal belongs, the information regarding the channel of the service domain to which the user's main view terminal belongs, and the like. The request for a transmission of the broadcast/video program from the session sever to the SDV transmission server may be performed through Internet group management protocol (IGMP) snooping using the IP address of the main view terminal.

The SDV transmission server receives the main view transmission request from the session server and transmits a broadcast/video program which can be viewed by the main view, namely, a main view, to the main view terminal (S380). The main view is generally a large, high picture image, and a channel transmitting the main view is a larger, faster channel than the channel for transmitting the preview.

When the broadcast/video program transmission scheme of the SDV transmission server is a multi-cast transmission scheme, the SDV transmission server checks whether or not the IP address of the user's main view terminal has been subscribed to a multi-cast group. When the IP address of the user's main view terminal has been subscribed to a multi-cast group, the SDV transmission server multicasts the user selected broadcast/video program. When the IP address of the user's main view terminal has not been subscribed to a multi-cast group, the SDV transmission server accepts a subscription to a multicast group with respect to the IP address of the user's main view terminal (S370) and multicasts the user selected broadcast/video program.

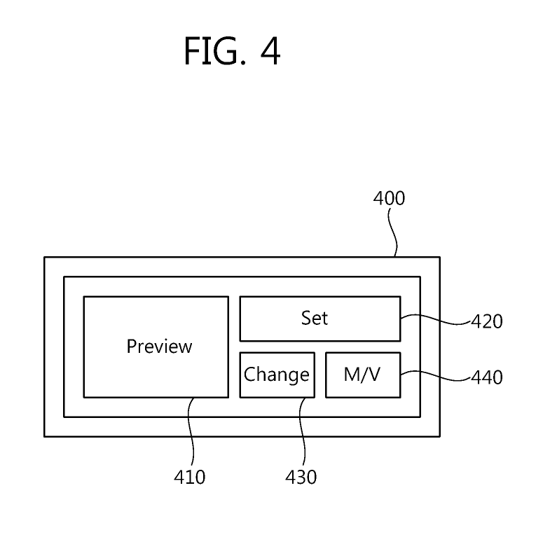

FIG. 4 is a view illustrating an example of the configuration of a screen of the preview terminal.

The preview terminal outputs the program guide received from the EPG server of the SDV system in various manners. The program guide may include, for example, the title of the broadcast/video program, a broadcast time, a still image of the broadcast/video program, and a brief instruction of the broadcast/video program.

When the user selects a desired broadcast/video program, namely, a desired channel, from the program guide output to the screen of the preview terminal 400, a preview 410 transmitted to the preview terminal 400 from the SDV transmission server can be viewed. In this case, the user may directly select a transmission of the desired broadcast/video program to the main view terminal from the program guide screen.

When the user requests the transmission of the broadcast/video program selected from the preview terminal 400 to the main view terminal, he may designate the information, e.g., an IP address, of the main view terminal through a setting 420 function.

The user may changing the broadcast/video program channel, the designated information of the main view terminal, or the like, through a change 430 function of the preview terminal 400. The user may transmit a request for a transmission of the user selected broadcast/video program to set information, e.g., the main view terminal of the designated IP address, by using a main view (M/V) 440 function of the preview terminal 400.

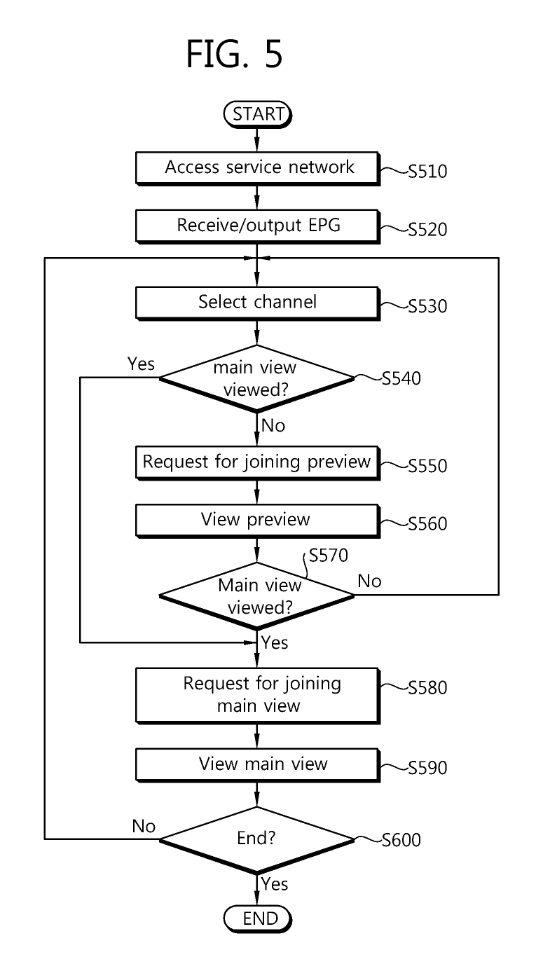

FIG. 5 is a flow chart illustrating the process of requesting a transmission of a broadcast/video program by the preview terminal according to an exemplary embodiment of the present invention.

The user, who wants to view a broadcast/video, is connected to the SDV service network through the preview terminal (S510). As described above, the user has been registered to use a service in advance through the terminal authentication server of the SDV system. The terminal authentication server of the SDV system may request an authentication for using a service, e.g., a service log-in, when the user is connected to the network according to a setting.

The preview terminal outputs a program guide received from the EPG server of the SDV system to the screen of the preview terminal (S520).

The user selects a desired broadcast/video program, namely, a channel, from the program guide output to the preview terminal (S530). The terminal authentication server of the SDV system may request the authentication for using the service, e.g., the service log-in, when the user selects a channel, according to a setting.

The user may determine to view the selected channel directly by the main view terminal, without viewing a preview (S540). In this case, the user transmits a main view join message to the SDV system from the preview terminal (S580). The terminal authentication server of the SDV system may request the authentication for using the service, e.g., the service log-in, when a main view image transmitted by the user is received, according to a setting.

The user may determine to first view the broadcast/video program by the preview terminal and transmit a preview join message to the SDV server (S550). In this case, the user may select his desired broadcast/video program, namely, a channel, from the program guide of the preview terminal to thus view a preview of the corresponding broadcast/video program through the preview terminal. Also, the preview terminal may have a preview view function differentiated from a main view view function. In this case, the user may select whether to view the broadcast/video program through the preview terminal or through the main view terminal.

The user may receive the selected broadcast/video program from the SDV system and view the same by the preview terminal (S560).

The user may determine whether to view the broadcast/video program, which is being viewed through the preview terminal, through the main view terminal (S570). In this case, the viewer may continue to view the broadcast/video program through the preview terminal or may select a channel again (S530).

When the user determines to view the broadcast/video program, which is being viewed through the preview terminal, through the main view terminal, the user transmits a main view join message from the preview terminal to the SDV system (S580). The terminal authentication server of the SDV system may request an authentication for using the service, e.g., a service log-in, when a main view message transmitted by the user is received, according to a setting.

The user may receive the selected broadcast/video program from the SDV system and view it through the main view terminal (S590). Preferably, the speed of data streaming transmitted to the main view terminal is faster than that of data streaming transmitted to the preview terminal. The data of the broadcast/video program transmitted to the main view terminal and the data of the broadcast/video program transmitted to the preview terminal are transmitted by using the data streamings each having a different rate, namely, a different data transmission capacity, thereby effectively utilizing the limited broadcast resources.

The user may terminate the viewing of the broadcast/video program (S600). When the user wants to view a different broadcast/video program, the user may select a desired broadcast/video program, e.g., a channel, by using the preview terminal again (S530). In this case, because the user's terminals have been authenticated, an additional authentication is not required.

Here, the preview terminal is used to select a broadcast/video program, but this is to easily explain the present invention and the present invention is not limited thereto. For example, the user may change or select channels on the main view terminal according to the performance of the main view terminal.

In the foregoing exemplary system, the methods are described based on the flow chart as sequential steps or blocks, but the present invention is not limited to the order of the steps and some of them may be performed in order different from the order of the foregoing steps or simultaneously. Also, a skilled person in the art will understand that the steps are not exclusive but may include other steps, or one or more steps of the flow chart may be deleted without affecting the scope of the present invention.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A method for requesting a transmission of a program by a terminal in a switched digital video (SDV)-based multi-screen system, the method comprising:
requesting, by a first terminal, a transmission of a selected program to a server;
receiving, by the first terminal, the program through first data streaming from the server;
outputting, by the first terminal, the program; and
to when the program is selected to be output to a second terminal, transmitting, by the first terminal, a program transmission request for requesting a transmission of the program to the second terminal, to the server.

2. The method of claim 1, wherein the program transmission request comprises information for designating the speed of second data streaming for transmitting the program from the server to the second terminal.

3. The method of claim 2, wherein the speed of the second data streaming is faster than that of the first data streaming.

4. The method of claim 1, wherein the second terminal may be a mobile terminal.

5. The method of claim 1, wherein the program transmission request comprises information regarding an IP address of the second terminal.

6. The method of claim 1, wherein the second data streaming is transmitted via a multicast channel.

7. A method for requesting a transmission of a program in a switched digital video (SDV)-based multi-screen system, the method comprising:
selecting, by a first terminal, a program to be output to a second terminal; and
transmitting, by the first terminal, a program transmission request for requesting a transmission of the program to the second terminal, to a server.

8. The method of claim 7, further comprising:
selecting, by the first terminal, the speed of data streaming of the program transmitted to the second terminal,
wherein the program transmission request may include information regarding the selected speed of data streaming.

9. The method of claim 8, wherein the selected speed of data streaming is faster than the speed of data streaming transmitted to the first terminal.

10. The method of claim 7, wherein the program transmission request is a request for transmitting the program from the second terminal through data streaming faster than the data streaming transmitted to the first terminal.

11. The method of claim 7, wherein the program transmission request comprises information regarding an IP address of the second terminal.

12. The method of claim 7, wherein the second terminal is a mobile terminal.

13. The method of claim 7, wherein the program transmission request is a request for transmitting the program to the second terminal via a multi-cast channel.

14. A method for transmitting a program by a server in a switched digital video (SDV)-based multi-screen system, the method comprising:
receiving a first transmission request for requesting a transmission of a program from a first terminal;
transmitting the program through first data streaming to the first terminal;
receiving a second transmission request for requesting a transmission of the program to a second terminal, from the first terminal; checking information regarding the domain of the second terminal; and
transmitting the program to the second terminal through second data streamlining.

15. The method of claim 14, wherein the speed of the second data streaming is faster than that of the first data streaming.

16. The method of claim 14, wherein the checking of the information regarding the domain of the second terminal comprises:
checking whether or not the second terminal has joined a multi-cast group,
wherein when the second terminal has joined a multi-cast group, the program is multicast through the second data streaming, and when the second terminal has not joined a multi-cast group, the second terminal joins a multi-cast group and the program is multicast through the second data streaming.

17. The method of claim 16, wherein whether or not the second terminal has joined a multi-cast group is checked by checking whether or not an IP address of the second terminal has joined the multi-cast group.

18. The method of claim 14, further comprising:
checking a channel transmission state with respect to the domain of the second terminal,
wherein the transmission speed of the second data streaming is regulated according to the channel transmission state.

19. The method of claim 14, further comprising:
checking a channel transmission state with respect to the domain of the second terminal,
wherein a transmission scheme with respect to the second terminal is determined according to the channel transmission state.
